(19) United States
(12) Patent Application Publication
(10) Pub. No.: US 2003/0084683 A1
(43) Pub. Date: May 8, 2003

(54) Foam glass and method of making

(76) Inventors: Robert Dejaiffe, Kennewick, WA (US); Mark Young, Benton City, WA (US)

Correspondence Address: Douglas E. McKinley, Jr., P.O. Box 202, Richland, WA, 99352, US

(21) Appl. No.: 10/011,944

(22) Filed: Nov. 5, 2001

(51) Int. Cl. C03B 19/08

(52) U.S. Cl. 65/17.5; 65/22

(57) ABSTRACT

A method of making a foam glass having a substantially uniform pore size by first providing a substantially homogenous mixture of a milled glass and an activated carbon foaming agent, and then heating said mixture in the presence of oxygen to a temperature sufficient to react said foaming agent with oxygen. Preferably, the mixture is heated to a temperature of between about 700° C. and about 850° C., and more preferably the mixture is heated to a temperature of between but not limited to about 750° C. and about 800° C. The milled glass is preferably provided as waste soda lime glass. Preferably, the carbon foaming agent is milled to a substantially uniform particle size of less than about 400 mesh, more preferably less than about 325 mesh, and more preferably less than about 270 mesh. Preferably, the glass precursor is milled to a substantially uniform particle size of less than about 400 mesh, more preferably less than about 325 mesh, and more preferably less than about 270 mesh.

### CROSS-REFERENCE TO RELATED APPLICATIONS

Not Applicable

### BACKGROUND OF THE INVENTION

It has long been known that foamed glass, a form of glass characterized by numerous voids within the glass, can be formed with a variety of organic and inorganic materials. By mixing a glass precursor with a proper foaming agent, and heating it to the melting temperature of the glass precursor, a foam glass may be formed. Voids are formed in the glass by a foaming agent that forms a gas at a temperature compatible with the melting characteristics of the glass.

Among the foaming agents that have been successfully used in forming foam glass are sulfate salts, primarily sodium (saltcake). The sodium participates in the melting reaction, releasing SO₂ in the reaction. This is convenient for glasses formed with a foam glass precursor such as soda-lime cullet, but there are drawbacks. In harder glasses, the sulfate salts may dissociate before the reaction starts, and the product smells of sulfur when cells are broken. Carbonate salts as the foaming agent have also been shown to generate foam glass, generating CO and/or CO₂ in a similar manner. The resulting product has no unpleasant odor, but the decomposition may occur too soon for successful foaming. Bound water can be a foaming agent, and can be found in perlite, some clays and other minerals. At least one commercial process forces water into soda-lime glass in an autoclave to trap it as the foaming agent. The release of the water at the right time to form cells is even more difficult, and may be limited to processes where the heating rate to the softening point can be very rapid. This works in very small product sizes such as perlite beads and single hollow glass cells, but becomes more difficult as the product size grows. This method has also been used where the product is heated in a microwave.

Carbon has also been shown to be useful a foaming agent. One drawback of carbon is that it oxidizes slowly, thus, it will start to oxidize before the glass softens, so it is difficult to provide the appropriate amount for oxidizing at the foaming temperature. In all of these methods, variables related to the reaction temperatures and reaction rates of the foaming agents have limited the consistency of the voids formed in the resulting foam glasses. The failure to produce consistently sized voids within the glass in turn produces inconsistent strength in the foam glass products made by the prior art methods, which hinders their usefulness in commercial applications.

These and other drawbacks of the prior art have created a need for methods and materials for forming foam glass that is consistent in its cell structure and form, and which are readily scalable to large scale processing operations.

### BRIEF SUMMARY OF THE INVENTION

Accordingly, the present invention is a method of making a foam glass product that provides a consistent pore size. The invention is enabled by the discovery that activated carbon produces an ideal reaction when heated with foam glass precursor. This reaction releases the correct amount of gas at the correct temperatures to allow the formation of a consistent product having consistent pore sizes within the foam glass. Foam glass formed with activated carbon thus exhibits a consistent strength profile, allowing the foam glass to be used in a variety of commercial applications.

Accordingly, the present invention is a method of making a foam glass having a substantially uniform pore size by first providing a substantially homogenous mixture of a milled glass and an activated carbon foaming agent, and then heating said mixture in the presence of oxygen to a temperature sufficient to react said foaming agent with oxygen. Preferably, the mixture is heated to a temperature of between about 700° C. and about 850° C., and more preferably the mixture is heated to a temperature of between about 750° C. and about 800° C. The present invention finds particular utility in providing a recycling pathway for waste soda lime glass as the glass precursor. Accordingly, it is preferred that the milled glass be provided as waste soda lime glass. The method of the present invention is preferably carried out by carefully controlling the particle sizes of both the activated carbon foaming agent and the glass precursor. Accordingly, it is preferred that both the milled glass and the activated carbon be milled to a substantially uniform particle size. Preferably, the carbon foaming agent is milled to a substantially uniform particle size of less than about 270 mesh, more preferably less than about 325 mesh, and more preferably less than about 400 mesh. Similarly, it is preferred that the glass precursor is milled to a substantially uniform particle size of less than about 270 mesh, more preferably less than about 325 mesh, and more preferably less than about 400 mesh.

The present invention finds particular utility in providing a pathway for the recycling of waste glass. Of particular note are glasses generated in high temperature waste treatment systems, such as those manufactured by Integrated Environmental Technologies, LLC of Richland Wash. These systems utilize a plasma heating system and are capable of transforming a wide variety of materials into a vitreous glass a high value synthesis gas. Accordingly, as used herein “waste glass” should be understood to encompass both post consumer waste glass and the glass products produced by these high temperature systems.

### DETAILED DESCRIPTION OF THE INVENTION

In a preferred embodiment of the present invention, the process starts with a glass of particle size suitable for feeding into a ball mill. There it is further reduced in size to a fine powder in the range of 10 to 50 microns. The glass powder is then mixed intimately with the activated carbon foaming agent. The prepared mix is then put into a mold for heating to the foaming temperature. The mold is preferably made of a non-stick material (such as carbon or aluminum nitride), or it can be made of a non-oxidizing metal coated with a suitable parting agent.

The filled and usually covered mold is placed into an oven or lehr to raise it to the foaming temperature. The appropriate peak temperature for foaming is dependent on the melting point of the glass and the slope of the viscosity curve at the melting point. A soft glass may foam at about 750 C. Typical soda-lime cullet is foamed at about 775 C. A hard glass may foam as high as 1000 C or more.

When the foaming temperature is reached, it is necessary to hold that temperature for a short period of time while the heat penetrates to the center of the material and the oxidation of the carbon is completed. The time required is dependent on the size and mass of the filled mold. After foaming, the temperature is reduced to the annealing point while stress is relieved, and then reduced to room temperature. The resulting foam object will have sealed surfaces, and a closed cellular structure. The density can be varied according to the packing of the glass powder and the amount of activated carbon foaming agent added.

It is generally desirable to complete the foaming operation as quickly as possible to avoid crystallization within the glass. If the oxidation of the activated charcoal is retarded by the lack of adequate oxygen within a closed mold, to the mold may be ventilated and/or an additional oxidizing agent, including but not limited to sodium nitrate may be added to the precursor mix.

Closure

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1) A method of making a foam glass having a substantially uniform pore size comprising the steps of:
a. providing a substantially homogenous mixture of a milled glass and an activated carbon foaming agent,
b. heating said mixture in the presence of oxygen to a temperature sufficient to react said foaming agent with oxygen.

2) The method of claim 1 wherein said mixture is heated to a temperature of between about 700° C. and about 850° C.

3) The method of claim 1 wherein said mixture is heated to a temperature of between about 750° C. and about 800° C.

4) The method of claim 1 wherein said milled glass is provided as waste soda lime glass.

5) The method of claim 1 wherein said milled glass is provided as waste glass derived from the processing of waste materials.

6) The method of claim 1 wherein said activated carbon foaming agent is milled to a substantially uniform particle size.

7) The method of claim 6 wherein said activated carbon foaming agent is milled to a substantially uniform particle size of less than about 270 mesh.

8) The method of claim 6 wherein said activated carbon foaming agent is milled to a substantially uniform particle size of less than about 325 mesh.

9) The method of claim 6 wherein said activated carbon foaming agent is milled to a substantially uniform particle size of less than about 400 mesh.

10) The method of claim 1 wherein said milled glass is milled to a substantially uniform particle size.

11) The method of claim 10 wherein said milled glass is milled to a substantially uniform particle size of less than about 270 mesh.

12) The method of claim 10 wherein said milled glass is milled to a substantially uniform particle size of less than about 325 mesh.

13) The method of claim 10 wherein said milled glass is milled to a substantially uniform particle size of less than about 400 mesh.

14) A method of making a foam glass having a substantially uniform pore size comprising the steps of:
a. milling a glass precursor to a substantially uniform particle size,
b. milling an activated carbon foaming agent to a substantially uniform particle size,
c. providing a mixture of said milled glass precursor and said milled carbon foaming agent,
d. heating said mixture in the presence of oxygen to a temperature sufficient to react said foaming agent with oxygen.

15) The method of claim 14 wherein said mixture is heated to a temperature of between about 700° C. and about 850° C.

16) The method of claim 14 wherein said mixture is heated to a temperature of between about 750° C. and about 800° C.

17) The method of claim 14 wherein said milled glass is provided as waste soda lime glass.

18) The method of claim 14 wherein said activated carbon foaming agent is milled to a substantially uniform particle size of less than about 270 mesh.

19) The method of claim 14 wherein said activated carbon foaming agent is milled to a substantially uniform particle size of less than about 325 mesh.

20) The method of claim 14 wherein said activated carbon foaming agent is milled to a substantially uniform particle size of less than about 400 mesh.

21) The method of claim 14 wherein said milled glass is milled to a substantially uniform particle size.

22) The method of claim 14 wherein said milled glass is milled to a substantially uniform particle size of less than about 270 mesh.

23) The method of claim 14 wherein said milled glass is milled to a substantially uniform particle size of less than about 325 mesh.

24) The method of claim 14 wherein said milled glass is milled to a substantially uniform particle size of less than about 400 mesh.

25) A method of making a foam glass having a substantially uniform pore size comprising the steps of:
a. milling a glass precursor consisting essentially of waste soda lime glass to a substantially uniform particle size,
b. milling an activated carbon foaming agent to a substantially uniform particle size,
c. providing a mixture of said milled glass precursor and said milled carbon foaming agent,
d. heating said mixture in the presence of oxygen to a temperature sufficient to react said foaming agent with oxygen.

26) The method of claim 25 wherein said mixture is heated to a temperature of between about 700° C. and about 850° C.

27) The method of claim 25 wherein said mixture is heated to a temperature of between about 750° C. and about 800° C.

28) The method of claim 25 wherein said activated carbon foaming agent is milled to a substantially uniform particle size of less than about 270 mesh.

29) The method of claim 25 wherein said activated carbon foaming agent is milled to a substantially uniform particle size of less than about 325 mesh.

30) The method of claim 25 wherein said activated carbon foaming agent is milled to a substantially uniform particle size of less than about 400 mesh.

31) The method of claim 25 wherein said milled glass is milled to a substantially uniform particle size.

32) The method of claim 25 wherein said milled glass is milled to a substantially uniform particle size of less than about 270 mesh.

33) The method of claim 25 wherein said milled glass is milled to a substantially uniform particle size of less than about 325 mesh.

34) The method of claim 25 wherein said milled glass is milled to a substantially uniform particle size of less than about 400 mesh.
